(19) United States
(12) Patent Application Publication
(10) Pub. No.: US 2025/0231214 A1
(43) Pub. Date: Jul. 17, 2025

(54) ACCELERATION SENSOR

(71) Applicant: AAC Kaitai Technologies (Wuhan) CO., LTD., Wuhan (CN)

(72) Inventors: Shitao Yan, Wuhan (CN); Lingcheng Kong, Wuhan (CN); Zhan Zhan, Wuhan (CN); Shan Yang, Wuhan (CN); Zhao Ma, Wuhan (CN); Xiao Kan, Wuhan (CN); Yang Li, Wuhan (CN); Kahkeen Lai, Singapore (SG); Qiuyu Tan, Singapore (SG)

(21) Appl. No.: 18/795,154

(22) Filed: Aug. 5, 2024

Related U.S. Application Data
(63) Continuation of application No. PCT/CN2024/072851, filed on Jan. 17, 2024.

(51) Int. Cl. G01P 15/125; G01P 15/08; G01P 15/18

(52) U.S. Cl. CPC G01P 15/125; G01P 15/18; G01P 2015/0831

(57) ABSTRACT

An acceleration sensor, including a base; anchor point; an inner side supporting unit, a middle part of which is fixed to the base through the anchor point, a first seesaw unit elastically connected to an outer side of a first end of the inner side supporting unit; a second seesaw unit elastically connected to an outer side of a second end of the inner side supporting unit; and an out-of-plane displacement detection unit. Each of the first seesaw unit and the second seesaw unit is symmetrically distributed about a symmetry axis of the acceleration sensor. The first seesaw unit includes two first seesaw structures at two sides of the symmetry axis and the second seesaw unit includes two second seesaw structures at two sides of the symmetry axis. An influence of Y-axis angular acceleration on the acceleration sensor is greatly reduced and a cross inhibition ratio thereof is improved.

### TECHNICAL FIELD

The present disclosure relates to the technical field of sensors, and in particular to an acceleration sensor.

### BACKGROUND

An acceleration sensor includes one or more detection weights for detecting acceleration. For example, an acceleration sensor includes a detection weight, and the detection weight is configured to move in a plane to detect acceleration in the plane of the detection weight, and configured to move out of a plane to detect acceleration in a plane perpendicular to the plane of the detection weight. The acceleration may be detected using a capacitive sensor coupled to the detection weight.

Currently, the acceleration sensor is easily affected by a y-axis angular acceleration when detecting the out-of-plane acceleration, and the cross inhibition is relatively low, which is not conducive to ensuring the detection accuracy of the out-of-plane acceleration by the acceleration sensor.

### SUMMARY

The present disclosure aims at solving at least one of the technical problems in the related art and provides a new technical solution of an acceleration sensor.

In an aspect, an embodiment of the present disclosure provides an acceleration sensor, including: a base; an anchor point; an inner side supporting unit including a first end and a second end, a middle part of the inner side supporting unit being fixed to the base through the anchor point; a first seesaw unit and a second seesaw unit; and an out-of-plane displacement detection unit provided at each of the first seesaw unit and the second seesaw unit. The first seesaw unit is elastically connected to an outer side of the first end of the inner side supporting unit, the second seesaw unit is elastically connected to an outer side of the second end of the inner side supporting unit; the first seesaw unit and the second seesaw unit are opposite to each other, and each of the first seesaw unit and the second seesaw unit is symmetrically distributed about a symmetry axis of the acceleration sensor; the first seesaw unit includes two first seesaw structures arranged at two sides of the symmetry axis, and the two first seesaw structures both rotate about a first rotation axis; the second seesaw unit includes two second seesaw structures arranged at two sides of the symmetry axis, and the two second seesaw structures both rotate about a second rotation axis; the first rotation axis and the second rotation axis are arranged in parallel, and the symmetry axis is perpendicular to the first rotation axis or the second rotation axis.

As an improvement, a first groove is provided at an outer side of the first seesaw unit, a second groove is provided at an inner side of the second seesaw unit, a part of the first seesaw unit is embedded in the second groove, and a part of the second seesaw unit is embedded in the first groove to form an embedded structure, which is located between the first rotation axis and the second rotation axis.

As an improvement, the acceleration sensor further includes a first detection weight and a second detection weight. Each first seesaw structure includes a first rotating sub-portion and a second rotating sub-portion, the first rotating sub-portion and the second rotating sub-portion are located at two opposite sides of the first rotation axis, and the first groove is provided at an outer side of the second rotating sub-portion; each second seesaw structure includes a third rotating sub-portion and a fourth rotating sub-portion, the third rotating sub-portion and the fourth rotating sub-portion are located at two opposite sides of the second rotation axis, and the second groove is provided at an inner side of the third rotating sub-portion. The first detection weight is located at the first rotating sub-portion, the second detection weight is located at the fourth rotating sub-portion, and the first detection weight and the second detection weight are symmetrically arranged.

As an improvement, the acceleration sensor further includes a coupling beam. The coupling beam extends in a direction perpendicular to the symmetry axis, an end of the coupling beam is connected to the second rotating sub-portion, and another end of the coupling beam is connected to the third rotating sub-portion.

As an improvement, the acceleration sensor further includes a first elastic member and a second elastic member. The first seesaw unit is connected to the first end of the inner side supporting unit through the first elastic member; and the second seesaw unit is connected to the second end of the inner side supporting unit through the second elastic member. The first elastic member is close to the first rotation axis and extends in a direction parallel to the first rotation axis; and the second elastic member is close to the second rotation axis and extends in a direction parallel to the second rotation axis.

As an improvement, the out-of-plane displacement detection unit is located at a region of the first seesaw unit away from the first rotation axis; and the out-of-plane displacement detection unit is located at a region of the second seesaw unit away from the second rotation axis.

As an improvement, the two inner side supporting units are symmetrically distributed about the symmetry axis; and each of the two inner side supporting units is fixed to the base through a respective anchor point located at an inner side of the inner side supporting unit.

As an improvement, the acceleration sensor further includes an X-axis acceleration detection structure configured to detect acceleration along an X-axis direction. The X-axis acceleration detection structure is located between the two inner side supporting units, and the X-axis acceleration detection structure is symmetrically distributed about the symmetry axis.

As an improvement, the acceleration sensor further includes a Y-axis acceleration detection structure configured to detect acceleration along a Y-axis direction. The Y-axis acceleration detection structure is located between the two inner side supporting units, and the Y-axis acceleration detection structure is symmetrically distributed about the symmetry axis.

As an improvement, the acceleration sensor further includes an X-axis acceleration detection structure and a Y-axis acceleration detection structure. The X-axis acceleration detection structure is configured to detect acceleration along an X-axis direction; and the Y-axis acceleration detection structure is configured to detect acceleration along a Y-axis direction. The X-axis acceleration detection structure and the Y-axis acceleration detection structure are both located between the two inner side supporting units, and the X-axis acceleration detection structure and the Y-axis acceleration detection structure are located at two opposite sides of the anchor point.

As an improvement, the two inner side supporting units are symmetrically distributed about the symmetry axis, and middle parts of the two inner side supporting units are connected to each other at a position of one anchor point located at a junction between the two inner side supporting units.

As an improvement, the acceleration sensor further includes an X-axis acceleration detection structure configured to detect acceleration along an X-axis direction. The X-axis acceleration detection structure is located between the two inner side supporting units, and the X-axis acceleration detection structure is symmetrically distributed about the symmetry axis.

As an improvement, the acceleration sensor further includes a Y-axis acceleration detection structure configured to detect acceleration along a Y-axis direction. The Y-axis acceleration detection structure is located between the two inner side supporting units, and the Y-axis acceleration detection structure is symmetrically distributed about the symmetry axis.

As an improvement, the acceleration sensor further includes an X-axis acceleration detection structure and a Y-axis acceleration detection structure. The X-axis acceleration detection structure is configured to detect acceleration along an X-axis direction; and the Y-axis acceleration detection structure is configured to detect acceleration along a Y-axis direction. The X-axis acceleration detection structure and the Y-axis acceleration detection structure are both located between the two inner side supporting units, and the X-axis acceleration detection structure and the Y-axis acceleration detection structure are located at two opposite sides of the anchor point.

### BRIEF DESCRIPTION OF DRAWINGS

FIG. 1 is a structural schematic diagram of an acceleration sensor according to embodiment I of the present disclosure;

FIG. 2 is a schematic diagram of a Z-axis detection mode of an acceleration sensor according to embodiment I of the present disclosure;

FIG. 3 is a schematic diagram of a Z-axis parasitic mode of an acceleration sensor according to embodiment I of the present disclosure;

FIG. 4 is a structural schematic diagram of an acceleration sensor according to embodiment II of the present disclosure;

FIG. 5 is a structural schematic diagram of an acceleration sensor according to embodiment III of the present disclosure;

FIG. 6 is a schematic diagram of a Z-axis detection mode of an acceleration sensor according to embodiment III of the present disclosure;

FIG. 7 is a structural schematic diagram of a coupling beam of an acceleration sensor according to an embodiment of the present disclosure;

FIG. 8 is an enlarged view of part A in FIG. 7;

FIG. 9 is a structural schematic diagram of a coupling beam of an acceleration sensor according to another embodiment of the present disclosure;

FIG. 10 is an enlarged view of part A in FIG. 9;

FIG. 11 is a structural schematic diagram of an acceleration sensor according to embodiment IV of the present disclosure;

FIG. 12 is a structural schematic diagram of an acceleration sensor according to embodiment V of the present disclosure;

FIG. 13 is a structural schematic diagram of an acceleration sensor according to embodiment VI of the present disclosure;

FIG. 14 is a structural schematic diagram of an X-axis acceleration detection structure of an acceleration sensor according to an embodiment of the present disclosure; and

FIG. 15 is a structural schematic diagram of a Y-axis acceleration detection structure of an acceleration sensor according to an embodiment of the present disclosure.

In the figures: 100: symmetry axis; 200: first rotation axis; 300: second rotation axis; 1: anchor point; 2: inner side supporting unit; 3: first seesaw unit; 31: first rotating sub-portion; 32: second rotating sub-portion; 33: first groove; 4: second seesaw unit; 41: third rotating sub-portion; 42: fourth rotating sub-portion; 43: second groove; 5: out-of-plane displacement detection unit; 61: first detection weight; 62: second detection weight; 7: coupling beam; 81: first elastic member; 82: second elastic member; 9: X-axis acceleration detection structure; 901: first weight; 9021: first positive fixed electrode; 9022: first negative fixed electrode; 903: first torsion spring; 904: first mounting groove; 10: Y-axis acceleration detection structure; 101: second weight; 1021: second positive fixed electrode; 1022: second negative fixed electrode; 103: second torsion spring; 104: second mounting groove.

### DESCRIPTION OF EMBODIMENTS

Various exemplary embodiments of the present disclosure are described in detail with reference to the drawings. It should be noted that: the relative arrangement of components and steps, numeric expressions and values described in the embodiments are not intended to limit the scope of the present disclosure, unless otherwise stated.

Embodiments of the present disclosure will be described in detail below, examples of which are shown in the accompanying drawings, same or similar numerals throughout indicate same or similar elements or elements with same or similar functions. Embodiments described below with reference to the accompanying drawings are illustrative and are only intended to illustrate the present disclosure shall not be interpreted as limitations on the present disclosure. All other embodiments obtained by those skilled in the art without paying creative labor shall fall into a protection scope of the present disclosure.

The feature defined by “first” and “second” in the specification and claims can indicate or imply to include one or more of the features. In the description of the present disclosure, unless otherwise indicated, “a plurality of” means two or more. In addition, “and/or” in the specification and claims indicates at least one of the associated objects, and the character “/” generally indicates that the associated objects are of an “or” relationship.

In the description of the present disclosure, it should be understood that the terms such as “center”, “longitudinal”, “transverse”, “length”, “width”, “thickness”, “upper”, “lower”, “front”, “rear”, “left”, “right”, “vertical”, “horizontal”, “top”, “bottom”, “inner”, “outer”, “clockwise”, “counterclockwise”, “axial”, “radial”, “circumferential” and the like indicate an orientation or position relationship based on the orientation or position relationship shown in the drawings, and merely for convenience in describing the present disclosure and simplifying the description, and do not indicate or imply that the referred device or element must have a specific orientation, be constructed and operated in a specific orientation, and therefore cannot be understood as a limitation on the present disclosure.

In the description of the present disclosure, it should be noted that, unless otherwise specified and limited, the terms such as “mount”, “connect” and “join” should be understood broadly, for example, it may be a fixed connection, a detachable connection, or an integral connection; it may be a mechanical connection, or an electrical connection; it may be a direct connection, or an indirect connection through an intermediate medium; or it may be an internal communication between two elements. For those of ordinary skill in the art, the specific meanings of the foregoing terms in the present disclosure can be understood on a case-by-case basis.

It should be noted that the in-plane X-axis direction detection mode refers to that the acceleration sensor is subjected to acceleration in the in-plane X-axis direction; the in-plane Y-axis direction detection mode refers to that the acceleration sensor is subjected to acceleration in the in-plane Y-axis direction; the out-of-plane Z-axis direction detection mode refers to that the acceleration sensor is subjected to acceleration in the out-of-plane Z-axis direction; and the out-of-plane Z-axis direction parasitic mode refers to that the acceleration sensor is subjected to both acceleration in the out-of-plane Z-axis direction and Y-axis angular acceleration.

### Embodiment I

Referring to FIGS. 1-3, in a first aspect, an embodiment of the present disclosure provides an acceleration sensor. In order to describe the acceleration sensor of the present disclosure conveniently, an X-Y-Z-axis three-dimensional coordinate system is established, a first direction is defined as an X-axis direction, a second direction is defined as a Y-axis direction, a third direction is defined as a Z-axis direction (that is, an out-of-plane direction), and the first direction, the second direction and the third direction are perpendicular to each other.

In an embodiment of the present disclosure, the acceleration sensor includes a base, an anchor point 1, an inner side supporting unit 2, a first seesaw unit 3, a second seesaw unit 4, and an out-of-plane displacement detection unit 5.

In an example, a middle part of the inner side supporting unit 2 is fixed to the base through the anchor point 1; and the inner side supporting unit 2 includes a first end and a second end.

In an example, the first seesaw unit 3 is elastically connected to an outer side of a first end of the inner side supporting unit 2, the second seesaw unit 4 is elastically connected to an outer side of a second end of the inner side supporting unit 2. The first seesaw unit 3 and the second seesaw unit 4 are oppositely arranged, and the first seesaw unit 3 and the second seesaw unit 4 are symmetrically distributed about a symmetry axis 100 of the acceleration sensor respectively. The first seesaw unit 3 forms two first seesaw structures at two sides of the symmetry axis 100, respectively, and the two first seesaw structures both rotate about a first rotation axis 200. The second seesaw unit 4 forms two second seesaw structures at two sides of the symmetry axis 100, respectively, and the two second seesaw structures both rotate about a second rotation axis 300. The first rotation axis 200 and the second rotation axis 300 are arranged in parallel, and the symmetry axis 100 is perpendicular to the first rotation axis 200 or the second rotation axis 300. The first rotation axis 200 and the second rotation axis 300 are distributed along the second direction, that is, along the Y-axis direction. The symmetry axis 100 is distributed along the X-axis direction.

The first seesaw unit 3 and the second seesaw unit 4 are each provided with the out-of-plane displacement detection unit 5.

In this embodiment of the present disclosure, the first seesaw unit 3 and the second seesaw unit 4 are used as the detection structure for detecting the out-of-plane acceleration, so that the first seesaw unit 3 and the second seesaw unit 4 may rotate reversely about the Y-axis direction under an action of the acceleration in the out-of-plane direction (i.e., the Z-axis direction), and the out-of-plane acceleration (i.e., the Z-axis acceleration) of the acceleration sensor can be detected by the out-of-plane displacement detection unit 5 arranged at the first seesaw unit 3 and the second seesaw unit 4. Meanwhile, when the two first seesaw structures or the two second seesaw structures are subjected to undesired Y-axis angular acceleration, the two first seesaw structures or the two second seesaw structures rotate in a same direction, and a capacitance change of the out-of-plane displacement detection unit 5 caused by the rotation in a same direction is offset when the out-of-plane displacement detection unit 5 detects, so that the arrangement of the two first seesaw structures and the two second seesaw structures greatly reduces an influence on the acceleration sensor caused by the Y-axis angular acceleration, thereby improving the cross inhibition ratio of the acceleration sensor, and improving the accuracy of the out-of-plane acceleration detection by the acceleration sensor.

In an example, a first groove 33 is provided at an outer side of the first seesaw unit 3, a second groove 43 is provided at an inner side of the second seesaw unit 4, a part of the first seesaw unit 3 is embedded in the second groove 43, a part of the second seesaw unit 4 is embedded in the first groove 33 to form an embedded structure, which is located between the first rotation axis 200 and the second rotation axis 300.

In the above implementations, the first seesaw unit 3 and the second seesaw unit 4 adopt an embedded structure. The embedded structure helps to extend the rotating arms of the first seesaw unit 3 and the second seesaw unit 4, and meanwhile, the out-of-plane displacement detection unit 5 can be arranged in a region farther from the rotation axis, so that the gain of out-of-plane acceleration detection is greater.

In an example, the acceleration sensor further includes a first detection weight 61 and a second detection weight 62.

Each first seesaw structure includes a first rotating sub-portion 31 and a second rotating sub-portion 32, and the first rotating sub-portion 31 and the second rotating sub-portion 32 are located at two opposite sides of the first rotation axis 200, respectively. A first groove 33 is formed at an outer side of the second rotating sub-portion 32. Each second seesaw structure includes a third rotating sub-portion 41 and a fourth rotating sub-portion 42, and the third rotating sub-portion 41 and the fourth rotating sub-portion 42 are located at two opposite sides of the second rotation axis 300, respectively. A second groove 43 is formed at an inner side of the third rotating sub-portion 41.

The first detection weight 61 is located at the first rotating sub-portion 31, the second detection weight 62 is located at the fourth rotating sub-portion 42, and the first detection weight 61 and the second detection weight 62 are symmetrically arranged.

In the above implementations, the first detection weight 61 and the second detection weight 62 form an asymmetric detection mass, and the asymmetric detection mass is located at a distal end of the seesaw structure, so that rotation of the first seesaw structure and the second seesaw structure caused by out-of-plane acceleration is more sensitive, thereby improving the gain of detection of the acceleration sensor.

In an example, a position where two first rotating sub-portions 31 are connected may be provided with a first detection mass, and a position where two fourth rotating sub-portions 42 are connected may be provided with a second detection mass, thereby helping to further increase a distance between the detection mass and the rotation axis, and thus significantly improving sensitivity of rotation of the first seesaw structure and the second seesaw structure caused by the out-of-plane acceleration, and further improving the gain of detection of the acceleration sensor.

In an example, the acceleration sensor further includes a first elastic member 81 and a second elastic member 82. The first seesaw unit 3 is connected to the first end of the inner side supporting unit 2 through the first elastic member 81, and the second seesaw unit 4 is connected to the second end of the inner side supporting unit 2 through the second elastic member 82.

The first elastic member 81 is close to the first rotation axis 200 and extends in a direction parallel to the first rotation axis 200, and the second elastic member 82 is close to the second rotation axis 300 and extends in a direction parallel to the second rotation axis 300.

In the above implementations, the first elastic member 81 and the second elastic member 82 enable the acceleration sensor to provide support for motion coupling of the first detection weight 61 and the second detection weight 62 in the third direction, thereby helping the acceleration sensor to implement a function of detection of out-of-plane acceleration.

In an example, the out-of-plane displacement detection unit 5 is located at a region of the first seesaw unit 3 away from the first rotation axis 200.

The out-of-plane displacement detection unit 5 is located at a region of the second seesaw unit 4 away from the second rotation axis 300.

In the above implementation, since part of the out-of-plane displacement detection unit 5 is located at the region of the first seesaw unit 3 away from the first rotation axis 200 and part of the out-of-plane displacement detection unit 5 is located at the region of the second seesaw unit 4 away from the second rotation axis 300, the gain of detection of the out-of-plane acceleration is greater.

In an example, two inner side supporting units 2 are symmetrically distributed about the symmetry axis 100. Each inner side supporting unit 2 is fixed to the base through an anchor point 1, and the anchor point 1 is located an inner side of the inner side supporting unit 2.

In the above implementation, on one hand, two anchor points 1 are located at the middle of the entire structure of the acceleration sensor, so that the acceleration sensor is less affected by factors such as stress, and the anti-interference capability of the acceleration sensor is improved; and on the other hand, the first seesaw unit 3 and the second seesaw unit 4 are fixed to the base indirectly through two anchor points 1, respectively, thereby improving the stability of the entire structure of the acceleration sensor.

### Embodiment II

An embodiment provides another acceleration sensor, a structure of which is basically the same as that of embodiment I, and only the different parts are described below.

In this embodiment, referring to FIG. 4, two inner side supporting units 2 are symmetrically distributed about the symmetry axis 100, the middle parts of the two inner side supporting units 2 are connected, and one anchor point 1 is arranged at a connection between the two inner side supporting units 2.

In the above implementation, the anchor point 1 is located at the middle of the entire structure of the acceleration sensor, so that the acceleration sensor is less affected by factors such as stress, and the anti-interference capability of the acceleration sensor is improved. Meanwhile, the interference capability of factors such as stress resistance of the acceleration sensor is further improved.

### Embodiment III

An embodiment provides another acceleration sensor, a structure of which is basically the same as that of embodiment I, and only the different parts are described below.

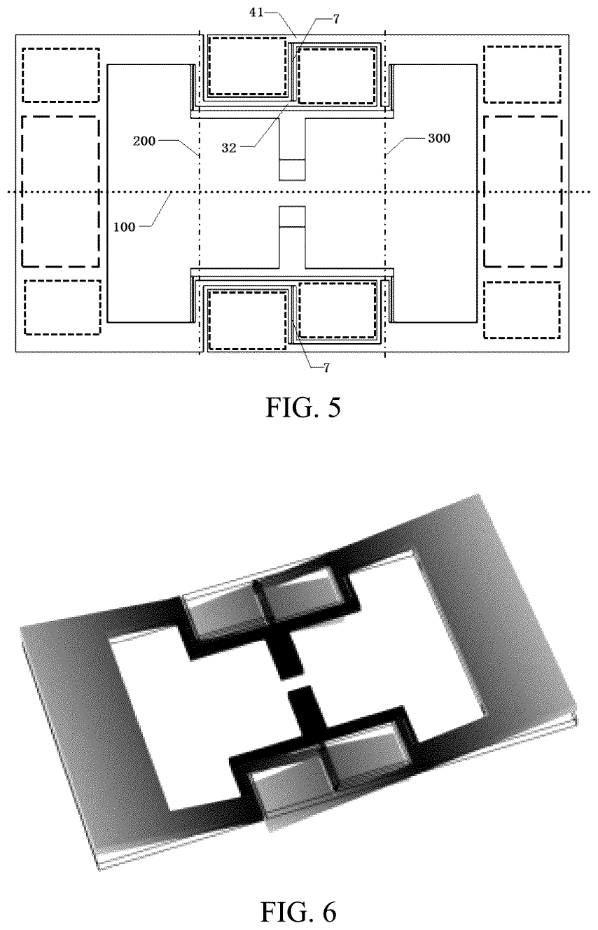

In this embodiment, referring to FIG. 5 to FIG. 10, the acceleration sensor further includes a coupling beam 7, the coupling beam 7 extends in a direction perpendicular to the symmetry axis 100. An end of the coupling beam 7 is connected to the second rotating sub-portion 32, and another end of the coupling beam is connected to the third rotating sub-portion 41.

In the above implementation, by providing the coupling beam 7 between the first seesaw unit 3 and the second seesaw unit 4, the coupling beam 7 can weaken a rotation of the first seesaw unit 3 and the second seesaw unit 4 towards a same direction, thereby further inhibiting an influence of the y-axis angular acceleration, and thus further improving the accuracy of detection of the out-of-plane acceleration by the acceleration sensor.

In an implementation, each of the first rotating sub-portion 31, the second rotating sub-portion 32, the third rotating sub-portion 41 and the fourth rotating sub-portion 42 is provided with an out-of-plane displacement detection unit 5, a part of the out-of-plane displacement detection unit 5 is located at a position of the first seesaw unit 3 away from the first rotation axis 200, and a part of the out-of-plane displacement detection unit 5 is located at a position of the second seesaw unit 4 away from the second rotation axis 300. A plurality of out-of-plane displacement detection units 5 are symmetrically distributed about the symmetry axis 100.

For example, referring to FIG. 5, the coupling beam 7 has a strip shape. An end of the coupling beam 7 is fixed to a bottom wall of the first groove 33, and another end of the coupling beam 7 is fixed to a bottom wall of the second groove 43. This makes a structure of the coupling beam 7 simple, thereby facilitating assembly of the acceleration sensor.

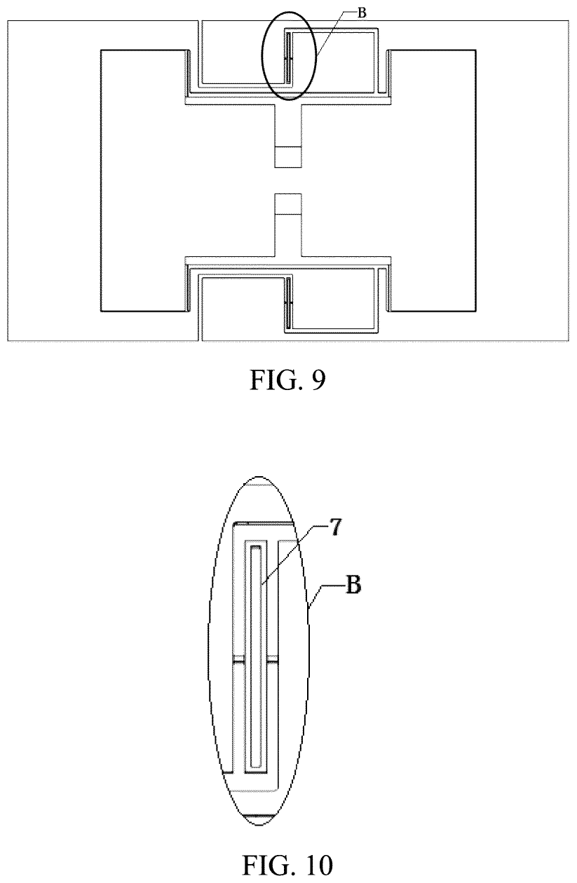

In some implementation manners, referring to FIG. 7 and FIG. 8, the coupling beam 7 includes two parallel sub-beams. An end of the sub-beam is fixed to a bottom wall of the first groove 33, and another end of the sub-beam is fixed to a bottom wall of the second groove 43. This further improves the capability of the coupling beam 7 to weaken rotation of the first and second seesaw units 3, 4 towards a same direction, thereby better inhibiting an influence of y-axis angular acceleration.

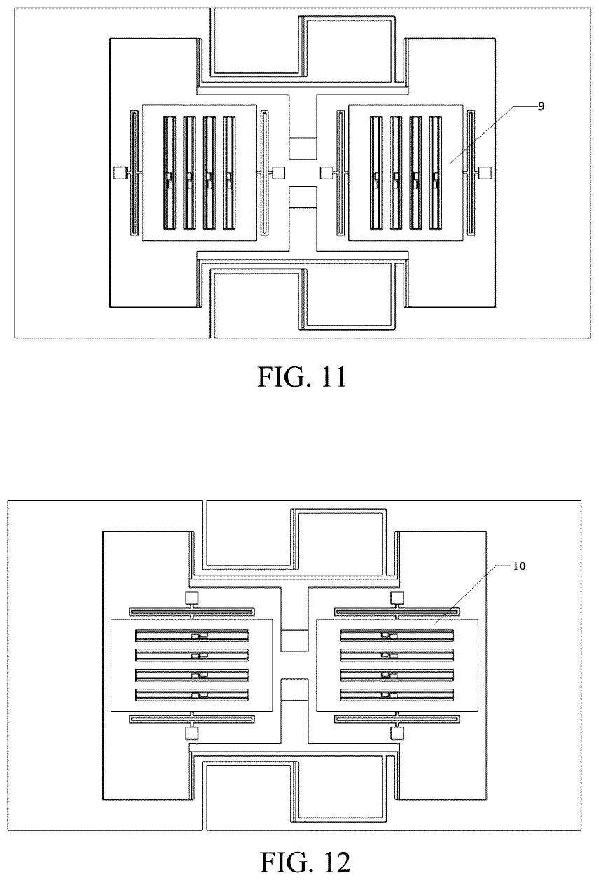

In some other implementation manners, referring to FIG. 9 and FIG. 10, the coupling beam 7 has a rectangular ring shape. A middle part of one side of the coupling beam 7 is fixed to an inner side wall of the first groove 33, and a middle part of another side of the coupling beam 7 is fixed to an inner side wall of the second groove 43. This makes the structural design of the coupling beam 7 reasonable, thereby effectively weakening rotation of the first seesaw unit 3 and the second seesaw unit 4 towards a same direction.

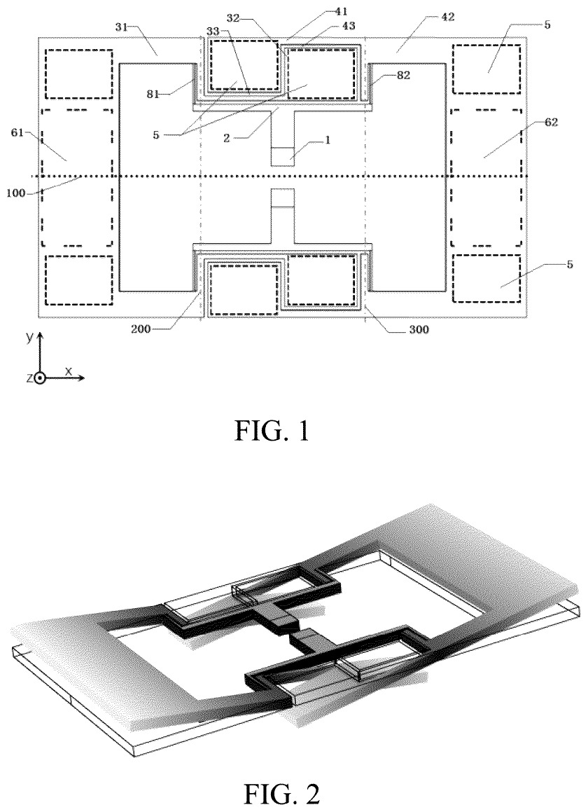

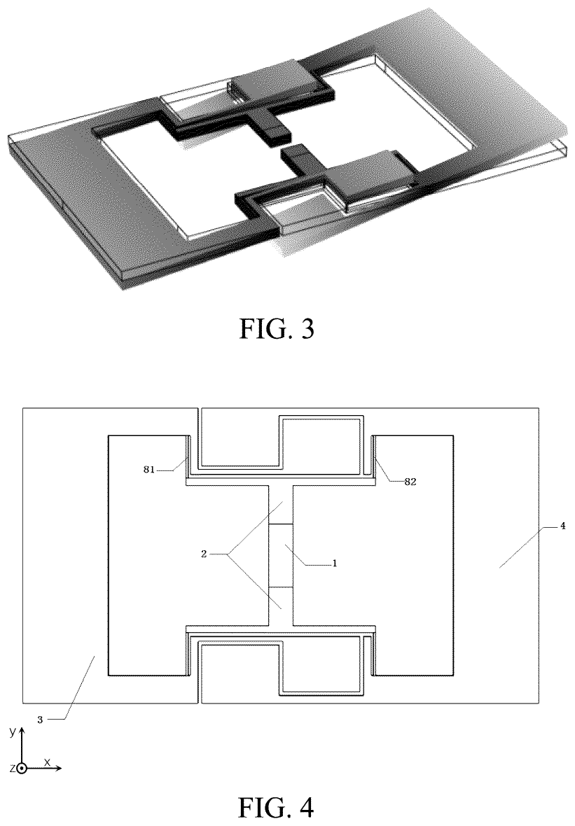

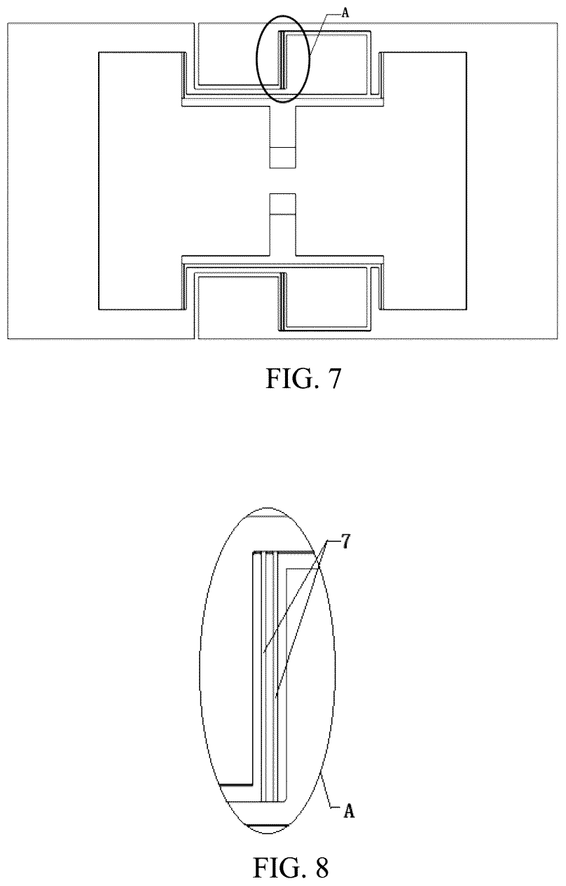

It should be noted that FIG. 2 is a schematic diagram of a Z-axis detection mode of an acceleration sensor without a coupling beam 7, FIG. 3 is a schematic diagram of a Z-axis parasitic mode of an acceleration sensor without a coupling beam 7, and FIG. 6 is a schematic diagram of a Z-axis detection mode of an acceleration sensor with a coupling beam 7. The out-of-plane displacement detection unit 5 detects acceleration in the Z-axis direction (that is, out-of-plane acceleration), so that the first seesaw unit 3 and the second seesaw unit 4 rotate reversely, but in the parasitic mode, the first seesaw unit 3 and the second seesaw unit 4 may rotate in a same direction about the Y-axis under an action of the Y-axis angular acceleration. In order to weaken an influence of the parasitic mode, the first seesaw unit 3 and the second seesaw unit 4 are connected to the coupling beam 7 to weaken an influence of the parasitic mode, that is, weaken rotation of the first seesaw unit 3 and the second seesaw unit 4 about the Y-axis towards a same direction, thereby further improving the cross inhibition ratio of the accelerometer and significantly improving the accuracy of detection of the acceleration sensor.

In an example, the out-of-plane displacement detection unit 5 includes a first out-of-plane detection plate and a second out-of-plane detection plate. The first out-of-plane detection plate and the second out-of-plane detection plate are opposite to each other and form a capacitor plate structure. The first out-of-plane detection plate is located at the base or a cavity cover, and the second out-of-plane detection plate is located at the first seesaw unit 3 and the second seesaw unit 4.

### Embodiment IV

An embodiment provides another acceleration sensor, a structure of which is basically the same as that of embodiment I, and only the different parts are described below.

In this embodiment, referring to FIG. 11, the acceleration sensor further includes an X-axis acceleration detection structure 9 configured to detect an acceleration along an X-axis direction.

The X-axis acceleration detection structure 9 is located between the two inner side supporting units 2, and the X-axis acceleration detection structure 9 is symmetrically distributed about the symmetry axis 100.

For example, two X-axis acceleration detection structures 9 are located at two opposite sides of the anchor point 1, respectively, and the two X-axis acceleration detection structures 9 are symmetrically arranged.

In the above implementation, the acceleration sensor can simultaneously detect acceleration in the X-axis direction and acceleration in the Z-axis direction, to form a biaxial accelerometer, which expands a detection range of the acceleration sensor.

### Embodiment V

An embodiment provides another acceleration sensor, a structure of which is basically the same as that of embodiment I, and only the different parts are described below.

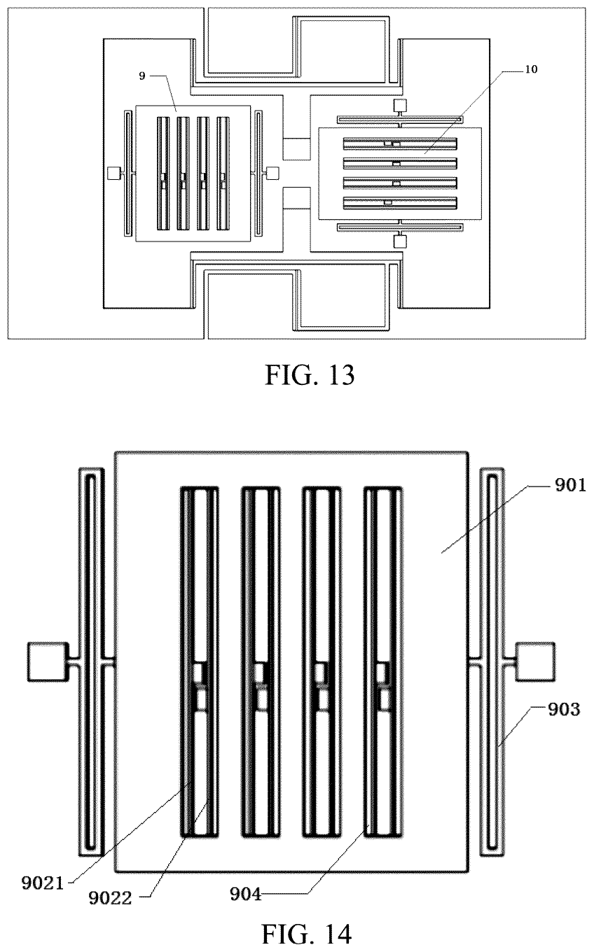

In this embodiment, referring to FIG. 12, the acceleration sensor further includes a Y-axis acceleration detection structure 10 configured to detect an acceleration along a Y-axis direction.

The Y-axis acceleration detection structure 10 is located between two inner side supporting units 2, and the Y-axis acceleration detection structure 10 is symmetrically distributed about the symmetry axis 100.

In the above implementation, the acceleration sensor can simultaneously detect acceleration in the Y-axis direction and acceleration in the Z-axis direction, to form a biaxial accelerometer, which expands a detection range of the acceleration sensor.

For example, two Y-axis acceleration detection structures 10 are located at two opposite sides of the anchor point 1, respectively, and the two Y-axis acceleration detection structures 10 are symmetrically arranged.

### Embodiment VI

An embodiment provides another acceleration sensor, a structure of which is basically the same as that of embodiment I, and only the different parts are described below.

In this embodiment, referring to FIG. 13, the acceleration sensor further includes an X-axis acceleration detection structure 9 and a Y-axis acceleration detection structure 10. The X-axis acceleration detection structure 9 is configured to detect an acceleration along an X-axis direction; and the Y-axis acceleration detection structure 10 is configured to detect an acceleration along a Y-axis direction.

The X-axis acceleration detection structure 9 and the Y-axis acceleration detection structure 10 are both located between the two inner side supporting units 2. The X-axis acceleration detection structure 9 and the Y-axis acceleration detection structure 10 are located at two opposite sides of the anchor point 1, respectively.

In the above implementation, the acceleration sensor can simultaneously detect acceleration in the X-axis direction, acceleration in the Y-axis direction and acceleration in the Z-axis direction, to form a three-axis accelerometer, which expands a detection range of the acceleration sensor and is very convenient to use.

For example, one X-axis acceleration detection structure 9 and one Y-axis acceleration detection structure 10 are provided, and respectively located at two opposite sides of the anchor point 1, thereby optimizing a structure of the acceleration sensor.

In an embodiment, referring to FIG. 14, the X-axis acceleration detection structure 9 includes a first weight 901 and a first capacitor group. Two sides of the first weight 901 are respectively fixed to the base through first torsion springs 903. First mounting grooves 904 are provided at a middle of the first weight 901, and are arranged at intervals along the Y-axis direction. Each first mounting groove 904 if provided with the first capacitor group. The first capacitor group includes a first positive fixed electrode 9021 and a first negative fixed electrode 9022. The first positive fixed electrode 9021 and the first negative fixed electrode 9022 are distributed along the Y-axis direction. A middle part of a side, close to the first negative fixed electrode 9022, of the first positive fixed electrode 9021 is anchored to the base; and a middle part of a side, close to the first positive fixed electrode 9021, of the first negative fixed electrode 9022 is anchored to the base. A side, away from the first negative fixed electrode 9022, of the first positive fixed electrode 9021 and the first weight 901 form a first differential detection capacitor; and a side, away from the first positive fixed electrode 9021, of the first negative fixed electrode 9022 and the first weight 901 form a second differential detection capacitor.

When the first weight 901 is displaced to left under an action of left acceleration along the X axis, a capacitance spacing of the first differential detection capacitor decreases and a capacitance spacing of the second differential detection capacitor increases, and the first differential detection capacitor and the second differential detection capacitor have a capacitance difference change proportional to the left acceleration along the X axis. In this way, a real-time value of the left acceleration along the X axis can be obtained by detecting the change of the capacitance difference.

Similarly, when the first weight 901 is displaced to right under an action of right acceleration along the X-axis, a real-time value of the right acceleration along the X-axis can be obtained by detecting the change of the capacitance difference.

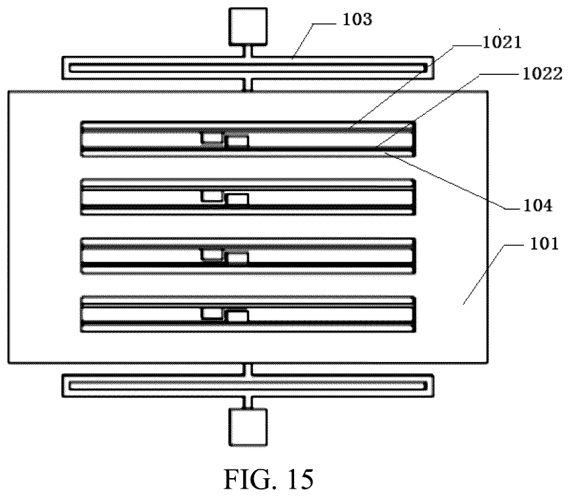

In another implementation, referring to FIG. 15, the Y-axis acceleration detection structure 10 includes a second weight 101 and a second capacitor group. Two sides of the second weight 101 are respectively fixed to the base through second torsion springs 103. Second mounting grooves 104 are provided at a middle of the second weight 101, and are arranged at intervals along the X-axis direction. Each second mounting groove 104 is provided with the second capacitor group. The second capacitor group includes a second positive fixed electrode 1021 and a second negative fixed electrode 1022. The second positive fixed electrode 1021 and the second negative fixed electrode 1022 are distributed along the X-axis direction. A middle part of a side, close to the second negative fixed electrode 1022, of the second positive fixed electrode 1021 is anchored to the base. A middle part of a side, close to the second positive fixed electrode 1021, of the second negative fixed electrode 1022 is anchored to the base. A side of the second positive fixed electrode 1021 away from the second negative fixed electrode 1022 and the second weight 101 form a third differential detection capacitor, and a side of the second negative fixed electrode 1022 away from the second positive fixed electrode 1021 and the second weight 101 form a fourth differential detection capacitor.

When the second weight 101 is displaced upward under an action of upward acceleration along the Y-axis, a capacitance spacing of the third differential detection capacitor decreases and a capacitance spacing of the fourth differential detection capacitor increases, the third differential detection capacitor and the fourth differential detection capacitor have a capacitance difference change proportional to acceleration along the Y-axis. In this way, a real-time value of upward acceleration along the Y-axis can be obtained by detecting the change of the capacitance difference.

Similarly, when the second weight 101 is displaced downward under an action of downward acceleration along the Y-axis, a real-time value of downward acceleration along the Y-axis can be obtained by detecting the change of the capacitance difference.

It can be understood that the above implementations are merely exemplary implementations used for illustrating the principles of the embodiments of the present disclosure, but the present disclosure is not limited thereto. For those skilled in the art, various modifications and improvements may be made without departing from the essence of the present disclosure, and these modifications and improvements shall fall within a protection scope of the present disclosure.

What is claimed is:

1. An acceleration sensor, comprising:
a base;
an anchor point;
an inner side supporting unit comprising a first end and a second end, a middle part of the inner side supporting unit being fixed to the base through the anchor point;
a first seesaw unit and a second seesaw unit; and
an out-of-plane displacement detection unit provided at each of the first seesaw unit and the second seesaw unit,
wherein the first seesaw unit is elastically connected to an outer side of the first end of the inner side supporting unit, the second seesaw unit is elastically connected to an outer side of the second end of the inner side supporting unit; the first seesaw unit and the second seesaw unit are opposite to each other, and each of the first seesaw unit and the second seesaw unit is symmetrically distributed about a symmetry axis of the acceleration sensor; the first seesaw unit comprises two first seesaw structures arranged at two sides of the symmetry axis, and the two first seesaw structures both rotate about a first rotation axis; the second seesaw unit comprises two second seesaw structures arranged at two sides of the symmetry axis, and the two second seesaw structures both rotate about a second rotation axis; the first rotation axis and the second rotation axis are arranged in parallel, and the symmetry axis is perpendicular to the first rotation axis or the second rotation axis.

2. The acceleration sensor as described in claim 1, wherein a first groove is provided at an outer side of the first seesaw unit, a second groove is provided at an inner side of the second seesaw unit, a part of the first seesaw unit is embedded in the second groove, and a part of the second seesaw unit is embedded in the first groove to form an embedded structure, which is located between the first rotation axis and the second rotation axis.

3. The acceleration sensor as described in claim 2, wherein further comprising a first detection weight and a second detection weight;
wherein each first seesaw structure comprises a first rotating sub-portion and a second rotating sub-portion, the first rotating sub-portion and the second rotating sub-portion are located at two opposite sides of the first rotation axis, and the first groove is provided at an outer side of the second rotating sub-portion; each second seesaw structure comprises a third rotating sub-portion and a fourth rotating sub-portion, the third rotating sub-portion and the fourth rotating sub-portion are located at two opposite sides of the second rotation axis, and the second groove is provided at an inner side of the third rotating sub-portion;
wherein the first detection weight is located at the first rotating sub-portion, the second detection weight is located at the fourth rotating sub-portion, and the first detection weight and the second detection weight are symmetrically arranged.

4. The acceleration sensor as described in claim 2, further comprising a coupling beam,
wherein the coupling beam extends in a direction perpendicular to the symmetry axis, an end of the coupling beam is connected to the second rotating sub-portion, and another end of the coupling beam is connected to the third rotating sub-portion.

5. The acceleration sensor as described in claim 1, further comprising a first elastic member and a second elastic member,
wherein the first seesaw unit is connected to the first end of the inner side supporting unit through the first elastic member; and the second seesaw unit is connected to the second end of the inner side supporting unit through the second elastic member; and
wherein the first elastic member is close to the first rotation axis and extends in a direction parallel to the first rotation axis; and the second elastic member is close to the second rotation axis and extends in a direction parallel to the second rotation axis.

6. The acceleration sensor as described in claim 1, wherein the out-of-plane displacement detection unit is located at a region of the first seesaw unit away from the first rotation axis; and
the out-of-plane displacement detection unit is located at a region of the second seesaw unit away from the second rotation axis.

7. The acceleration sensor as described in claim 1, wherein the two inner side supporting units are symmetrically distributed about the symmetry axis; and each of the two inner side supporting units is fixed to the base through a respective anchor point located at an inner side of the inner side supporting unit.

8. The acceleration sensor as described in claim 7, further comprising an X-axis acceleration detection structure configured to detect acceleration along an X-axis direction,
wherein the X-axis acceleration detection structure is located between the two inner side supporting units, and the X-axis acceleration detection structure is symmetrically distributed about the symmetry axis.

9. The acceleration sensor as described in claim 7, further comprising a Y-axis acceleration detection structure configured to detect acceleration along a Y-axis direction,
wherein the Y-axis acceleration detection structure is located between the two inner side supporting units, and the Y-axis acceleration detection structure is symmetrically distributed about the symmetry axis.

10. The acceleration sensor as described in claim 7, further comprising an X-axis acceleration detection structure and a Y-axis acceleration detection structure,
wherein the X-axis acceleration detection structure is configured to detect acceleration along an X-axis direction; and the Y-axis acceleration detection structure is configured to detect acceleration along a Y-axis direction; and
wherein the X-axis acceleration detection structure and the Y-axis acceleration detection structure are both located between the two inner side supporting units, and the X-axis acceleration detection structure and the Y-axis acceleration detection structure are located at two opposite sides of the anchor point.

11. The acceleration sensor as described in claim 1, wherein the two inner side supporting units are symmetrically distributed about the symmetry axis, and middle parts of the two inner side supporting units are connected to each other at a position of one anchor point located at a junction between the two inner side supporting units.

12. The acceleration sensor as described in claim 11, further comprising an X-axis acceleration detection structure configured to detect acceleration along an X-axis direction,
wherein the X-axis acceleration detection structure is located between the two inner side supporting units, and the X-axis acceleration detection structure is symmetrically distributed about the symmetry axis.

13. The acceleration sensor as described in claim 11, further comprising a Y-axis acceleration detection structure configured to detect acceleration along a Y-axis direction,
wherein the Y-axis acceleration detection structure is located between the two inner side supporting units, and the Y-axis acceleration detection structure is symmetrically distributed about the symmetry axis.

14. The acceleration sensor as described in claim 11, further comprising an X-axis acceleration detection structure and a Y-axis acceleration detection structure,
wherein the X-axis acceleration detection structure is configured to detect acceleration along an X-axis direction; and the Y-axis acceleration detection structure is configured to detect acceleration along a Y-axis direction; and
wherein the X-axis acceleration detection structure and the Y-axis acceleration detection structure are both located between the two inner side supporting units, and the X-axis acceleration detection structure and the Y-axis acceleration detection structure are located at two opposite sides of the anchor point.
